(19) United States
(12) Patent Application Publication
(10) Pub. No.: US 2015/0227984 A1
(43) Pub. Date: Aug. 13, 2015

(54) Promotional Router

(71) Applicants: Patrick Michael Mullen, San Juan Bautista, CA (US); Jericho Alexander Mullen, San Juan Bautista, CA (US)

(72) Inventors: Patrick Michael Mullen, San Juan Bautista, CA (US); Jericho Alexander Mullen, San Juan Bautista, CA (US)

(21) Appl. No.: 14/176,643

(22) Filed: Feb. 10, 2014

(51) Int. Cl. G06Q 30/02

(52) U.S. Cl. CPC G06Q 30/0277

(57) ABSTRACT

A smart router executes software that receives script for web pages requested by appliances on a WIFI provided by the router, strips advertisements from the scripts, and replaces the advertisements with promotional material from data storage in the router. The router executes a variety of programs implemented to enhance financial performance of an enterprise that hosts the router.

### BACKGROUND OF THE INVENTION

1. Field of the Invention

The present invention is in the field of Internet searches, routers and advertisement, and pertains more particularly to a specialized router that also strips ads from web pages and replaces same with different ads.

2. Description of Related Art

Placement of ads in web pages and stripping of ads so users won't see them is a well-known technology. The inventor in the present case has realized that replacing such ads with different ads, and doing so in certain special circumstances may be a very desirable improvement on ad stripping systems, and has provided a system for doing so in various different circumstances.

### BRIEF SUMMARY OF THE INVENTION

In one embodiment of the invention a router is provided, comprising a port connecting to the Internet network, circuitry providing a WIFI network, a processor having a coupled data repository storing one or more instances of promotional material defined as scripts compatible with Internet web page script, and software executing on the processor from a non-transitory medium, the software providing a process receiving from a computerized appliance connected to the router on the WIFI network a request for a web page from the Internet network, receiving script defining the web page requested from the Internet, identifying an advertisement in the script received from the Internet, noting, from the portion of the script received defining the advertisement, the size and placement of the advertisement, stripping the portion of the script defining the advertisement from the script received, selecting an instance of promotional material from the data repository, amending the script defining the promotional material selected to define the size and placement of the advertisement stripped, inserting the amended script defining the promotional material into the script of the web page script, and sending the changed web page script to the computerized appliance that requested the web page.

In one embodiment two or more advertisements are identified in the script received from the Internet, and wherein the one or more instances of promotional material defined as scripts compatible with Internet web page script are prioritized, and the promotional material is selected and used to replace the identified advertisements in the order of identifying the advertisements, and in the order of prioritization. Also in one embodiment two or more adjacent advertisements are stripped and replaced by one instance of promotional material resized and placed to occupy the space and position of the two or more advertisements stripped.

In one embodiment there may be an interactive configuration interface accessible by a host person from a computerized appliance connected to the router from the Internet or the WIFI provided by the router, the interface enabling the host person to upload and add promotional material to the data repository coupled to the processor, to delete instances of promotional material from the data repository, and to configure the router to follow individual programs in operation. Also in one embodiment the host person is enabled to add to, replace, or edit the software executable on the processor.

Also in one embodiment the router may be coupled on the local network to an inventory management server for the host enterprise, and the software executing on the router may comprise a program enabling the router to automatically select promotional material for replacing advertisements according to regularly updated inventory parameters received from the inventory management server. In one embodiment the software executing on the router further comprises a program enabling the router to select promotional material for replacing advertisements according to any one of a variety of business goals.

In some embodiments promotional material stored in the data repository may comprise promotional material for one or more enterprises other than the enterprise host of the router. In these embodiments the enterprise host and the other enterprises may engage in an agreement regarding selection of promotional material and sharing in financial results of the activities of the router. Further, instances of promotional material may promote one or more charitable causes.

In another aspect of the invention a method is provided, comprising steps of (a) implementing a router having a port connecting to the Internet network, circuitry providing a WIFI network, a processor having a coupled data repository storing one or more instances of promotional material defined as scripts compatible with Internet web page script, and software executing on the processor from a non-transitory medium in an enterprise setting; (b) receiving from a computerized appliance connected to the router on the WIFI network a request for a web page from the Internet network; (c) receiving script defining the web page requested from the Internet; (d) identifying an advertisement in the script received from the Internet; (e) noting, from the portion of the script received defining the advertisement, the size and placement of the advertisement; (f) stripping the portion of the script defining the advertisement from the script received; (g) selecting an instance of promotional material from the data repository; (h) amending the script defining the promotional material selected to define the size and placement of the advertisement stripped; (i) inserting the amended script defining the promotional material into the script of the web page script; and (j) sending the changed web page script to the computerized appliance that requested the web page.

In one embodiment of the method two or more advertisements may be identified in the script received from the Internet, and wherein the one or more instances of promotional material defined as scripts compatible with Internet web page script are prioritized, and the promotional material is selected and used to replace the identified advertisements in the order of identifying the advertisements, and in the order of prioritization. Also in one embodiment two or more adjacent advertisements may be stripped and replaced by one instance of promotional material resized and placed to occupy the space and position of the two or more advertisements stripped.

In one embodiment the method further comprises an interactive configuration interface accessible by a host person from a computerized appliance connected to the router from the Internet or the WIFI provided by the router, the interface enabling the host person to upload and add promotional material to the data repository coupled to the processor, to delete instances of promotional material from the data repository, and to configure the router to follow individual programs in operation. Also in one embodiment the host person may be enabled to add to, replace, or edit the software executable on the processor. Further in one embodiment of the method the router is coupled on the local network to an inventory management server for the host enterprise, and the software executing on the router comprises a program enabling the router to automatically select promotional material for replacing advertisements according to regularly updated inventory parameters received from the inventory management server.

In one embodiment the software executing on the router may further comprise a program enabling the router to select promotional material for replacing advertisements according to any one of a variety of business goals. In some embodiments promotional material stored in the data repository may include promotional material for one or more enterprises other than the enterprise host of the router. In such a case the enterprise host and the other enterprises may engage in an agreement regarding selection of promotional material and sharing in financial results of the activities of the router. Further, promotional material may promote one or more charitable causes.

### BRIEF DESCRIPTION OF THE SEVERAL VIEWS OF THE DRAWINGS

FIG. 1 is an architectural diagram illustrating arrangement of elements in an embodiment of the present invention.

FIG. 2 depicts an example interactive interface in an embodiment of the present invention.

FIG. 3 is an example of a web page containing advertisements that may be replaced in an embodiment of the present invention.

FIG. 4 is a flow diagram showing steps in a process in an embodiment of the invention.

FIG. 5 is a flow diagram showing steps in another process in an embodiment of the present invention.

### DETAILED DESCRIPTION OF THE INVENTION

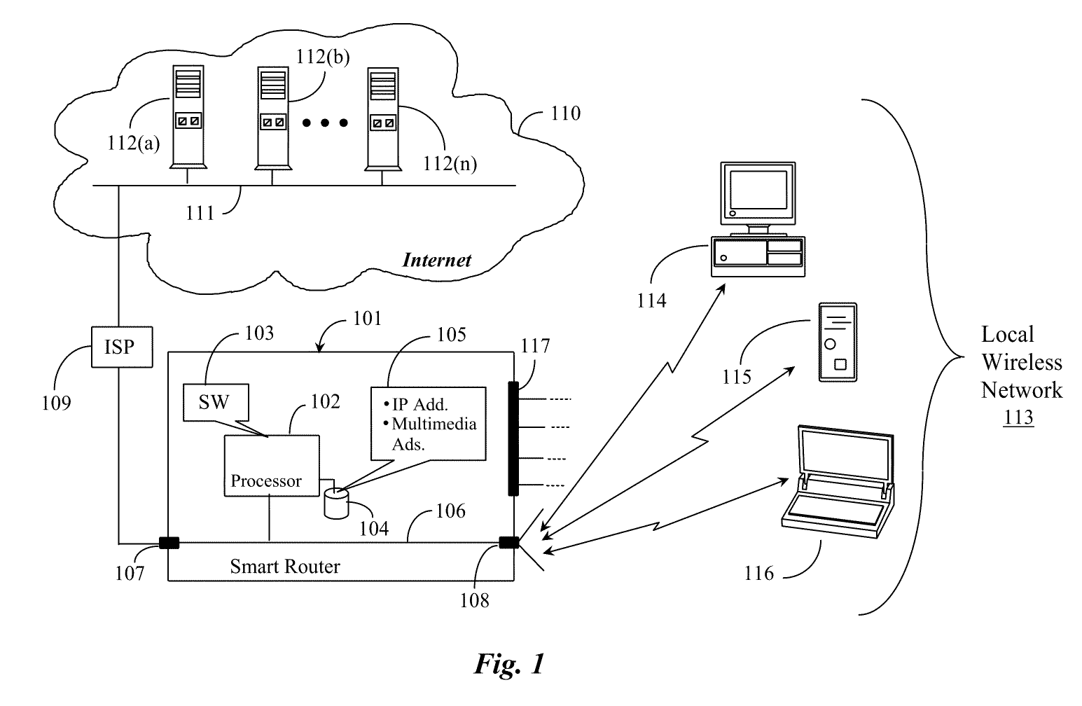

FIG. 1 is an architectural diagram illustrating arrangement of elements in an embodiment of the present invention. In this exemplary architecture a router 101 has a processor 102 executing software 103, execution of which provides a variety of functions described below, one unique function being stripping of advertisements from web pages that are accessed through the router, and replacement of the stripped ads with ads provided by a host of the router.

In one embodiment processor 102 has access to a date repository 104 which may be any sort of suitable digital memory known in the art. Repository 104 stores an IP address by which router 101 may be accessed through the Internet or other digital network, and are variety of multimedia advertisements and other material, useful in operation of the router, also described in enabling detail below. Router 101 has an Internet access port 107 through which the router may communicate with Internet network 110 through an Internet Service Provider (ISP) 109, representing any of many know ways that a router may access the Internet. For example, the line from port 107 may be an ISDN service provided by a public telephone company, with Internet access provided at the head end by the telephone company. There are many ways known in the art for such access.

Internet network 110 as depicted in FIG. 1 has an Internet backbone 111 which is meant to represent all of the lines and connections that make up the Internet as a whole. Several Internet connected servers 112(a), 112(b) to 112(n) are shown connected to backbone 111. The Internet connected servers may host web pages for a variety of different private enterprises, government organizations, news services and the like.

Router 101 provides a local wireless access network 113 through a wireless transceiver and associated circuitry represented here by port 108. Router 101 may also provide wired network service via a port 117. A variety of computerized appliances, such as computer 114, smart telephone 115 and laptop computer 116 are shown as connecting to router 101 via the wireless network. These same devices and others may also connect hard-wired through port 117. These three devices are representative of many computerized appliances that may be enabled to access router 101 either wirelessly or by hardwired connection. In descriptions below, reference is made primarily to wireless access, but the reader should understand that the access may be hard-wired as well.

Router elements are connected by a backbone 106 representing interconnections between circuitry in the router. There may also be power supplied to router elements from external power sources and from on-board battery, for example, none of which is shown but may be assumed to be present for functionality. Functionality and capability of router 101 may be described by use case. In one example of use router 101 may be installed and operable in a coffee shop that also sells pastries, ground coffee and related products. SW 103 provides an interactive user interface that enables a manager or other person in the enterprise to access the router and to upload advertisements to repository 104. This may be done through the Internet from just about any location by asserting the IP address of the router, which will then provide a web page presenting an interactive interface to the manager. A manager may access and configure router 101, for example, using a laptop computer 116 via the local WIFI network provided through transceiver 108, of may access through the Internet and port 107 using an Internet-capable appliance from anywhere.

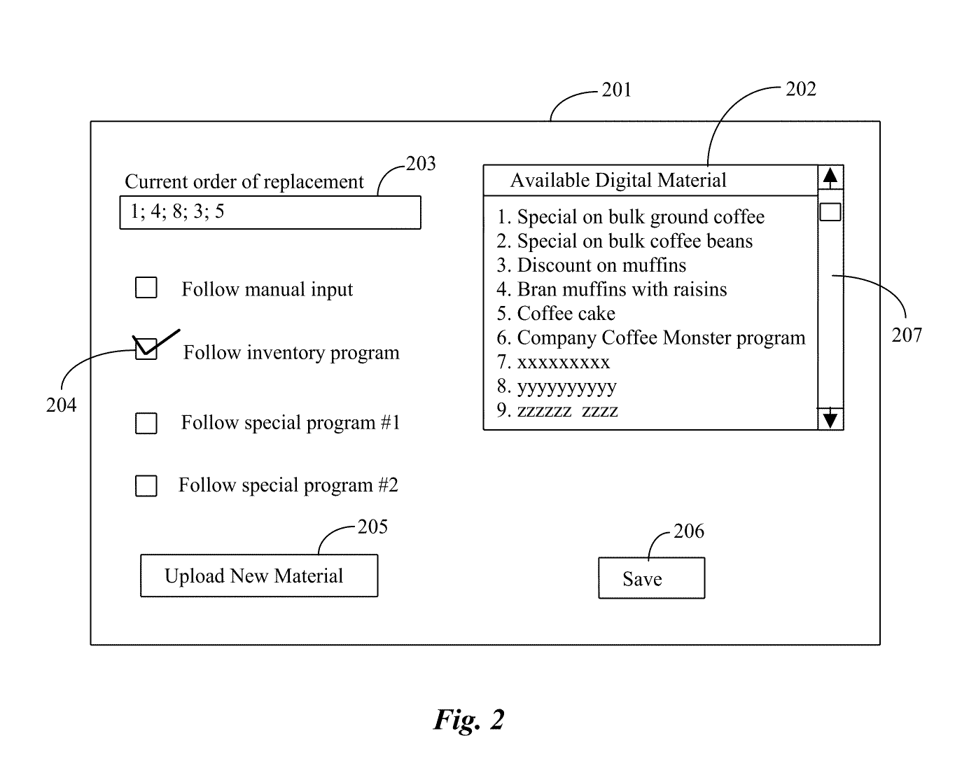

An exemplary configuration interface 201 is shown in FIG. 2. In this exemplary interface a listing 202 lists available digital material that may be selected to replace advertisements in web pages server through router 101. In this example of a coffee shop multimedia digital material may be provided to promote Bulk Ground Coffee, as noted in item #1 in the list. Item #1 mat reference a static ad showing one or two types of ground coffee being featured by the coffee shop, along with still photography of bags of the ground coffee. Alternatively item #1 may reference an animated advertisement for bulk ground coffee. Again alternatively item #1 may reference a video showing an employee of the coffee shop handling and displaying bags of bulk ground coffee. There are a great many possibilities. Similarly, item #2 may be any one of many possibilities of material promoting bulk coffee beans for sale. Item #6 may present program promoting point accumulation for regular customers. There is very little limit on the types or range of material that may be saved to be displayed, within the bounds of propriety. There is, in this example, a scroll bar 207 enabling a user to scroll up and down through the list of materials provided for replacing advertisements in web pages.

In this example a link 205 is provided for uploading new material to be added to list 202 to be available for and prioritized for replacing advertisements in web pages. Selecting link 205 in this example opens a window allowing a user to browse digital content in data repositories in a computerized appliance connected to router 101. Selecting digital content may cause the selected content to be uploaded to repository 104, and in a default mode that content will then be displayed in window 202 numbered in the order of deposit into repository 104. A user may change the order by dragging and dropping in window 202, and may also delete items in repository 104 by right-clicking and selecting Delete. Further, any material listed in window 202 may be reviewed by double-clicking on the listing. If one were to double-click on item #3, for example, an advertisement promoting a discount on muffins may be reviewed.

In this manner, in this embodiment, a user hosting router 101 in an enterprise or other organization may maintain a stable of multimedia material, typically promotional, to be used to replace advertisements in web pages browsed by persons using computerized appliances in WIFI network 113 (FIG. 1). Regular maintenance may of course be practiced, to avoid having too many listed digital replacements in window 202, and to keep the range of materials manageable. Promotional material may also be, in some embodiments, time and date stamped, and may be managed to expire on certain dates and times.

In interactive interface 201 a field 203 is provided that is interactive, and displays the order in which materials in window 202 will be used to replace advertisements in web pages. In this example items 1, 4, 8, 3, and 5 are listed left to right as the order of replacement. This means, in this example, if a web page is being processed through router 101, and one advertisement is discovered, that advertisement will be stripped, courtesy of execution of a part of SW 103, and item #1 from window 202 will be inserted into the place in the website formerly occupied by the one advertisement discovered. If two ads are discovered, items 1 and 4 will be used as replacements in that preferential order. If five advertisements are discovered, items 1, 4, 8, 3 and 5 will be used as replacements in that order. In some embodiments parameters may be programmed such that replacement preference may be based proportionally. That is, for example, ad #1 may be used 10% of the time, ad #4 25% of the time, and ad #8 30% of the time.

In an embodiment a host person accessing interactive interface 201 may edit the order of replacement in window 203, changing the order or the numbers represented or both. A series of check boxes 204 are provided wherein the host person may select for the router to follow manual input, or to follow any one of a variety of automatic programs. When the host person is done the new configuration may be saved by selecting button 206.

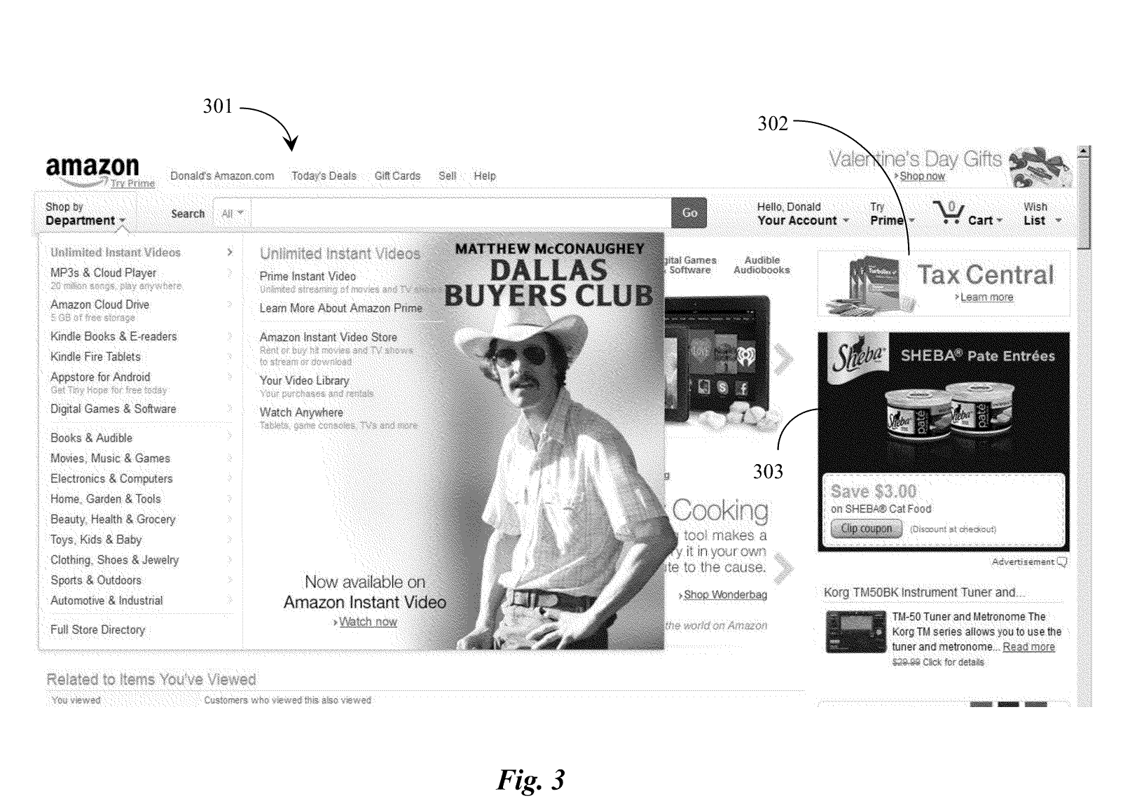

In the process of discovery and replacement, router 101, by execution of SW 103, reads the script behind the web page being processed, and determines advertisements by the nature of the script. This is a process that will be known to the skilled person. For example, FIG. 3 shows a web page 301 browsed from Amazon.com™. Two ads 302, for a service called “Tax Central” and 303, for “Sheba Pate Entrees”, are indicated (among others). One may view the script behind the page in a browser, such as Firefox or Internet Explorer, and manually read through the script to discover the script that is pertinent to the ads. The associated script will reference perhaps an image, such as a .png image, perhaps text, which may be associated with a link, and will also size the ad relative to the page size, and will dictate placement of the ad in the page.

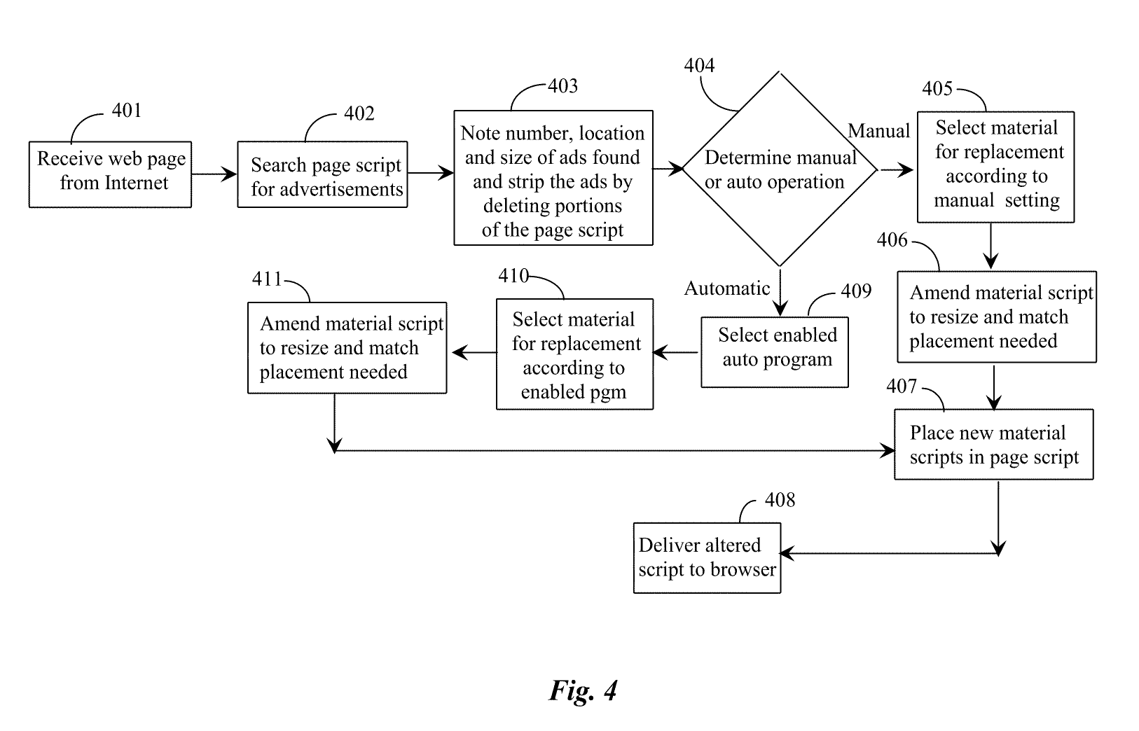

Software 103 executing on processor 102 performs the tasks of ad discovery and replacement automatically using special search and replace functions. FIG. 4 is a flow diagram that describes a process for this functionality. At step 401 in FIG. 4 router 101 receives a web page from the Internet, requested by a user operating one of the computerized appliances connected to the router in the WIFI network. At step 402 the router, executing SW 103, searched the page script for advertisements, which may be recognized by the nature of the script in various parts. At step 403 the router notes the number, location and size of each advertisement found, and then strips the ads by deleting the associated portions of the underlying page script. At step 404 the router checks for mode of operation, of which there may be several. If the operating mode is manual, then there will be an ordered sequence of replacement materials for inserting into the page script, and the router selects the correct new script portions in the order manually set. At step 406 the router amends the script portion for each replacement script portion to the size and placement of the advertisement being replaced. At step 407 the router places the new material script portions into the page script.

If at step 404 it is determined that operation is automatic, control goes to step 409 instead of step 405. At step 409 the router selects the enabled auto program. Some examples of auto programs are described below in enabling detail. At step 410, running the auto program, the router selects material from list 202 according to functionality of the auto program being executed. At step 411 the router amends the material script portions to resize and match placement parameters. Then control goes to step 407, and the new material script portions are placed on the underlying page script. At step 408 the altered script is delivered to the browser executing on the computerized appliance that requested the web page. The skilled person will recognize that the functions of the software may be accomplished in a variety of ways, and the order of operations described above is not limiting to the invention. The steps may be accomplished in a different order.

An important application for the router and methods of the invention is in applying the router at a place of business that does retail sales, as described in the example above for a coffee shop, and also provides WIFI for its customers, for example. Following that example further, it is well known that in a business like a coffee shop there are issues in daily operation having to do with what regular products are available for sale, what current inventory might be at different points in time, what products are known to sell better at certain times of the business day, what products might profitably be offered to customers to complement products they have just purchased or in the act of purchasing. Such information may be gathered continually or periodically, and may be stored in repository 104 for use by SW 103, and SW 103 may have functionality for selecting ads for insertion into web pages browsed by customers according to the changing data regarding product availability and priority as described above.

In one embodiment the router may coupled on the local network to an inventory management server for the host enterprise, and the software executing on the router may have a program enabling the router to automatically select promotional material for replacing advertisements according to regularly updated inventory parameters received from the inventory management server.

In some embodiments SW 103 may include functionality to be triggered at step 404 of FIG. 4. If the host operative has set the router to “automatic”, which may be determined in the scenario of FIG. 2 by any one of the boxes checked other than “manual input”, then at step 404 control goes to step 409, which determines which one of perhaps several automatic sequences to follow. Assume for descriptive purpose that the host operative has checked the box “Follow inventory program”.

For use of inventory parameters in automatic selection of ads for insertion into web pages the available materials (see list 202 of FIG. 2) should be reordered according to the inventory parameters. This may be done automatically at the time configuration is set to use the inventory program, but could be done manually by the host operative. There may be, in some embodiments, more than one ordered list, and different lists may even have different ads, with or without overlap.

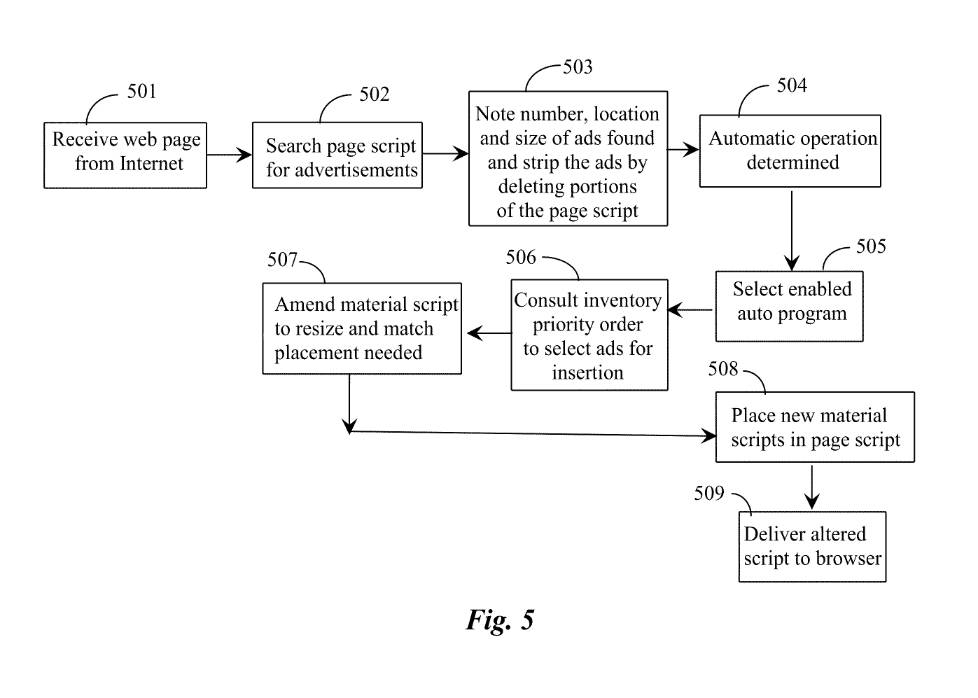

FIG. 5 is a flow diagram for describing how operation might proceed to select according to inventory parameters. Steps 501 through 504 are the same as for the more general diagram of FIG. 4. At step 504 it is determined that automatic operation is selected and at 505 that it is the inventory program that is to be followed. At step 506 the router consults the priority order provided by inventory parameters. As described above, that may be done beforehand or provided in a separate list to be available at any time. At step 507 the selected material is resized as needed, at step 508 material is placed into the web page script, and at step 509 the amended web page is delivered to the browsing customer.

There are many potential programs that may be prepared and loaded to router 101 to enhance performance of the business hosting the router. In some instances a special program (see FIG. 2 check boxes 204) may emphasize sales goals or trends. In some cases the business may be a franchise, and a parent company may push different products at different times. In some cases as well, ad replacement may be done to drive business goals of a business or businesses in close proximity to the business hosting the router. For example, several businesses in a local area may form a cooperative with one business hosting the router in an embodiment of this invention. In such a case there may well be a contract, and a flexible operating agreement. In such a case ads placed in web pages for browsing customers might promote products in neighboring businesses in the cooperative.

Another example of a business hosting a router according to an embodiment of the present invention is a residence enterprise, such as a hotel that offers WIFI to guests of the hotel, and perhaps also to visitors. In this case replacement material will be prepared to promote hotel services and amenities. Material to be inserted may promote restaurants, provide menus, promote room service, promote shows (Las Vegas, for example), massage and other health services may be promoted. In the case of cooperative promotion a hotel's router may promote nearby restaurants and retail outlets, and may even provide services for travel and hotel stays in the future.

In one embodiment of the invention promotional material placed into web pages in place of advertisements stripped from those pages. This variation opens a new avenue of promotional material for the host of the router in embodiments of the invention. Through interactive links in placed promotional material browsing customers may be directed to programs the host is promoting for any reason, such as charity donations and charity events, and may be led to register into various programs that may, for example, provide point accumulation for future shopping, frequent flyer rewards, and the like.

In many embodiments of the invention there may be a statistical server that tracks operation of the system and the reaction of customers to promotional material inserted. The stat server may also be programmed to provide reports of various sorts at various intervals regarding operations of the system, which may be used to manually tune the system (configuration) going forward, or in some embodiments may be programmed to effect automatic operation of the system. For example, in a situation where a particular product is being pushed results may be tracked for a time period, and then the promotion may discontinue if there are no good results, or be applied more diligently if the results are good.

The inventor has realized that too many advertisements stripped and replaced with promotional material may result in an inability of a browsing person to pay attention to individual ones of the promotions. Accordingly an embodiment is provided wherein, even if script for a received web page has several advertisements that might be stripped and replaced, the process is truncated once a first advertisement is identified, and consequently only one replacement is made. In making the one replacement other functionality described above may be implemented, such as selecting the promotional material according to any one of automatic programs that may have been implemented in the router.

In yet another embodiment additional intelligence is provided in SW 103 to analyze the script of the received page, and to find instances of adjacent advertisements that may be stripped, the stripping providing a space larger than stripping one of the advertisements, such that one instance of promotional material may be sized and inserted into the larger space provided. This way a promotional piece may be provided to the browsing person that is larger and perhaps more noticeable than would have been the case in a one-to-one replacement.

The skilled person will realize that the examples described in this specification are, in fact, exemplary, and represent specific application of a broader invention. There will be many ways that functions of the machine intelligence of the router described may be implemented and accomplished, and functions described may be applied in different ways in different circumstances without departing from the scope of the invention. The invention is limited only by the claims that follow.

1. A system comprising:
a router having a port connecting to the Internet network, circuitry providing a local WIFI network and a processor coupled to a data repository, the router operating at a position providing WIFI connectivity to customers at a host commercial enterprise offering products directly to the customers within the range of the WIFI network, the data repository storing one or more local advertisements defined as scripts compatible with Internet web page script, the local advertisements promoting one or more of the products offered directly to the customers in the host commercial enterprise; and
software executing on the processor from a non-transitory medium, the software providing a process:
receiving from a computerized appliance connected to the router on the WIFI network a request for a web page from the Internet network;
receiving script defining the web page requested from the Internet network;
identifying an original advertisement in the script received from the Internet network;
stripping a portion of the script defining the original advertisement from the script received;
consulting an inventory management server managing product inventory for the host commercial enterprise for status of inventory for products that are subjects of individual ones of the local advertisements;
selecting a local advertisement from the data repository based on the status of inventory determined; and
inserting the selected local advertisement in the web page script in place of the stripped original advertisement.

2. The system of claim 1 wherein two or more original advertisements are identified in the script received from the Internet network, and wherein the local advertisements are prioritized, and wherein local advertisements are selected and used to replace the original advertisements in the order of identifying the original advertisements, and in the order of prioritization of the local advertisements.

3. The system of claim 2 wherein two or more adjacent original advertisements are stripped and replaced by one local advertisement resized and placed to occupy the space and position of the two or more original advertisements stripped.

4. The system of claim 1 wherein the software further provides an interactive configuration interface accessible from a computerized appliance connected to the router from the Internet network or the WIFI network provided by the router, the interface enabling adding or deleting local advertisements to or from the data repository coupled to the processor and configuring the router to execute individual software programs from the data repository.

5. The system of claim 4 wherein the software enables addition, replacement or editing of the individual software programs executable on the processor.

6. (canceled)

7. The system of claim 1 wherein the software executing on the router further comprises a program enabling the router to select local advertisement for replacing original advertisements according to any one of a variety of business goals.

8. The system of claim 1 wherein local advertisements stored in the data repository local advertisements for one or more second commercial enterprises other than the host commercial enterprise sharing the range of the WIFI provided the router, the one or more second commercial enterprises in the immediate geographic area of the host commercial enterprise.

9. The system of claim 8 wherein the host commercial enterprise and the second commercial enterprises engage in an agreement regarding selection of advertisements and sharing in financial results of the activities of the router.

10. The system of claim 1 wherein instances of local advertisements promote one or more charitable causes.

11-20. (canceled)

21. A method comprising steps:
receiving at an Internet-connected router a request for a web page from a computerized appliance connected to the router through a local WIFI network providing WIFI connectivity by the router to customers at a host commercial enterprise offering products directly to the customers within the range of the WIFI network, the router having a processor coupled to a data repository storing one or more local advertisements defined as scripts compatible with Internet web page script, the local advertisements promoting one or more of the products offered directly to the customers in the host commercial enterprise;
receiving script at the router defining the web page requested from the Internet;
identifying an original advertisement in the script received from the Internet network;
stripping the portion of the script defining the original advertisement from the script received;
consulting an inventory management server managing product inventory for the host commercial enterprise for status of inventory for products that are subjects of individual ones of the local advertisements;
selecting a local advertisement from the data repository based on the status of inventory determined; and
inserting the selected local advertisement in the web page script in place of the stripped original advertisement.

22. The method of claim 21 wherein two or more original advertisements are identified in the script received from the Internet network, and wherein the local advertisements are prioritized, and wherein local advertisements are selected and used to replace the original advertisements in the order of identifying the original advertisements, and in the order of prioritization of the local advertisements.

23. The method of claim 22 wherein two or more adjacent original advertisements are stripped and replaced by one local advertisement resized and placed to occupy the space and position of the two or more original advertisements stripped.

24. The method of claim 21 wherein the software further provides an interactive configuration interface accessible from a computerized appliance connected to the router from the Internet network or the WIFI network provided by the router, the interface enabling adding or deleting local advertisements to or from the data repository coupled to the processor and configuring the router to execute individual software programs from the data repository.

25. The method of claim 24 wherein the software enables addition, replacement or editing of the individual software programs executable on the processor.

26. (canceled)

27. The method of claim 21 wherein the software executing on the router further comprises a program enabling the router to select local advertisement for replacing original advertisements according to any one of a variety of business goals.

28. The method of claim 21 wherein local advertisements stored in the data repository local advertisements for one or more second commercial enterprises other than the host commercial enterprise sharing the range of the WIFI provided the router, the one or more second commercial enterprises in the immediate geographic area of the host commercial enterprise.

29. The method of claim 28 wherein the host commercial enterprise and the second commercial enterprises engage in an agreement regarding selection of advertisements and sharing in financial results of the activities of the router.

30. The method of claim 1 wherein instances of local advertisements promote one or more charitable causes.
